(19) United States
(12) Patent Application Publication
(10) Pub. No.: US 2023/0084873 A1
(43) Pub. Date: Mar. 16, 2023

(54) SWIRL-TYPE DEMULSIFICATION AND DEHYDRATION DEVICE FOR OIL-WATER EMULSION

(71) Applicant: CHONGQING TECHNOLOGY AND BUSINESS UNIVERSITY, Chongqing (CN)

(72) Inventors: Ye PENG, Chongqing (CN); Haifeng GONG, Chongqing (CN); Haohua ZHANG, Chongqing (CN); Zhi QIU, Chongqing (CN)

(21) Appl. No.: 17/983,494

(22) Filed: Nov. 9, 2022

(30) Foreign Application Priority Data
Feb. 18, 2022 (CN) 202210152364.6

(51) Int. Cl. B01D 17/02; B01D 17/04

(52) U.S. Cl. CPC B01D 17/0217; B01D 17/041; B01D 2257/80

(57) ABSTRACT

A swirl-type demulsification and dehydration device for oil-water emulsions, including a swirler. An open end of a swirl chamber of the swirler faces towards an underflow pipe and communicates with the underflow pipe through a composite curved pipe section coaxial with the swirl chamber. A large-diameter end of a concave arc transition section is connected to the open end of the swirl chamber, is the same with the swirl chamber in inner diameter. A large-diameter end of a straight cone transition section is tangent to a small-diameter end of the concave arc transition section. A small-diameter end of the straight cone transition section is tangent to a large-diameter end of a convex elliptical arc transition section. A small-diameter end of the convex elliptical arc transition section is connected to the underflow pipe.

### CROSS-REFERENCE TO RELATED APPLICATIONS

This application claims the benefit of priority from Chinese Patent Application No. 202210152364.6, filed on Feb. 18, 2022. The content of the aforementioned application, including any intervening amendments thereto, is incorporated herein by reference in its entirety.

### TECHNICAL FIELD

The present disclosure relates to the liquid physical separation, and more particularly to a swirl-type demulsification and dehydration device for an oil-water emulsion.

### BACKGROUND

The comprehensive utilization of industrial waste oil is of great practical significance to environmental protection, alleviation of resource shortage and national strategy. The industrial waste oil firstly needs to be demulsified and dehydrated. The existing treatment methods cannot effectively demulsify and dehydrate emulsions when used alone, so multiple approaches are combined, or a coupling unit is adopted to reach a better separation effect. Typically, the electric field method and the swirl centrifugation method are integrated, that is, the electric field and the swirl centrifugal field are coupled. Under the action of the electric field, the liquid collision in the emulsion is intensified, and the droplet coalescence is promoted, forming larger droplets. Based on the density difference, the swirl centrifugal field produces different centrifugal forces for oil and water to realize the oil-water separation.

The electric field and the swirl centrifugal field are coupled by using a swirl device, for example, Chinese patent application No. 201811485648.7 discloses an electrostatic swirl demulsification device and an application thereof. With respect to the existing swirl devices, the swirl chamber and the underflow pipe, which are coaxial but vary in diameter, are connected generally through a straight double-cone section. The straight double-cone section has a stepped structure, which makes the transition between the swirl chamber and the underflow pipe unsmooth, such that the internal flow field is prone to vibration, resulting in low stability, and poor droplet coalescence and separation effect. To address this problem, Chinese patent application No. 202110545860.3 discloses a demulsification and dehydration method for emulsions, in which a smooth dual-spherical surface transition section is adopted as the transition structure between the swirl chamber and the underflow pipe. The smooth dual-spherical surface transition section is formed by a convex arc section and a concave arc section through the smooth tangent connection, which can effectively alleviate the droplet vibration and improve the separation effect.

However, as demonstrated by extensive practical verifications and theoretical analyses, although the smooth transition structure can effectively reduce the droplet vibration and improve the separation effect compared with the straight double-cone section, it still struggles with some deficiencies. Specifically, the convex arc transition section has a larger space than the corresponding area in the straight double-cone section, which will decrease the centrifugal force acting on the droplets, thereby affecting the separation effect. The concave arc transition section has a smaller space than the corresponding area in the straight double-cone section, which leads to the reduction of the tangential cone angle and downward resistance, such that a small amount of oil is prone to flowing to the underflow pipe, thereby affecting the separation effect. In addition, it has been found that the relationship between the diameter of the inlet pipe and the diameter of the swirl chamber will also significantly influence the separation performance. Therefore, it is necessary to further optimize the swirl device to arrive at the desired separation characteristic.

### SUMMARY

In view of the deficiencies in the prior art, this application provides a swirl-type demulsification and dehydration device for oil-water emulsions, which has a stable flow field and an improved separation performance.

Technical solutions of this application are described as follows.

This application provides a swirl-type demulsification and dehydration device for an oil-water emulsion, including:

a swirler;

wherein the swirler includes a swirl chamber and an underflow pipe; the swirl chamber is cylindrical, and the underflow pipe is coaxial with the swirl chamber;

the swirl chamber includes a closed end and an open end; the closed end of the swirl chamber is connected with an inlet pipe and an overflow pipe; the overflow pipe is coaxial with the swirl chamber; the inlet pipe is tangent to a circumferential inner wall of the swirl chamber, and communicates with the swirl chamber; the overflow pipe passes insulatively through the closed end of the swirl chamber, and communicates with the swirl chamber; a wall of the swirl chamber and the overflow pipe are made of a conductive material;

the open end of the swirl chamber faces towards the underflow pipe, and communicates with the underflow pipe through a composite curved pipe section; and the composite curved pipe section is coaxial with the swirl chamber;

on an axial section of the swirl, an inner wall of the composite curved pipe section comprises a concave arc transition section, a straight cone transition section and a convex elliptical arc transition section connected sequentially; and

a first end of the concave arc transition section is connected to the open end of the swirl chamber; an inner diameter of the first end of the concave arc transition section is equal to an inner diameter of the swirl chamber; a first end of the straight cone transition section is tangent to a second end of the concave arc transition section; a second end of the straight cone transition section is tangent to a first end of the convex elliptical arc transition section; a second end of the convex elliptical arc transition section is connected to the underflow pipe; the first end of the concave arc transition section is larger than the second end of the concave arc transition section in diameter; the first end of the straight cone transition section is larger than the second end of the straight cone transition section in diameter; the first end of the convex elliptical arc transition section is larger than the second end of the convex elliptical arc transition section in diameter; and an inner diameter of the second end of the convex elliptical arc transition section is equal to an inner diameter of the underflow pipe.

In an embodiment, the number of the inlet pipe is two; two inlet pipes are centrosymmetric with respect to an axis of the swirl chamber; and a relationship between an inner diameter of each of the two inlet pipes and the inner diameter of the swirl chamber is expressed as follows:

Dᵢ=0.00312Dₛ² (1);

wherein Dᵢ represents the inner diameter of each of the two inlet pipes, and Dₛ represents the inner diameter of the swirl chamber.

In an embodiment, a central angle corresponding to the concave arc transition section and an eccentric angle corresponding to the convex elliptical arc transition section are both less than 90°.

In an embodiment, with respect to a spatial rectangular coordinate system established at a center of an end of the underflow pipe with an extending direction of an axis of the underflow pipe towards the overflow pipe as a positive direction of z-axis, points on the convex elliptical arc transition section satisfy formula (2):

$$x - b \sqrt{1 - \frac{z - {L}_{u}}{a}} = \frac{{D}_{u}}{2} , {L}_{u} \leq z \leq {L}_{u} + {L}_{1} ; \qquad ( 2 )$$

wherein x and z represent coordinates of a point on an inner wall of the swirler on the x-axis and z-axis, respectively; a represents to a major axis of an ellipse corresponding to the convex elliptical arc transition section, and the major axis is in the same direction with an axis of the swirler; b represents a minor axis of the ellipse corresponding to the convex elliptical arc transition section; Lᵤ represents a length of the underflow pipe; Dᵤ represents the inner diameter of the underflow pipe; and L₁ represents a length of the convex elliptical arc transition section.

In an embodiment, points on the straight cone transition section satisfy formula (3):

$$x + K ( {L}_{u} + {L}_{1} ) - {K}_{z} = \sqrt{1 - \frac{{L}_{1}}{a}} + \frac{{D}_{u}}{2} , {L}_{u} + {L}_{1} \leq z \leq {L}_{u} + {L}_{1} + {L}_{2} ; \qquad ( 3 )$$

wherein K is a constant and satisfies formula (4):

$$K = \frac{\frac{{D}_{s} - {D}_{u}}{2} - \sqrt{{R}_{0}^{2} - {L}_{s}^{2}} + b \cdot \sqrt{1 - \frac{{L}_{3}}{a}}}{{L}_{2}} ; \qquad ( 4 )$$

wherein Ds represents the inner diameter of the swirl chamber; L₂ represents a length of the straight cone transition section; L₃ represents a length of the concave arc transition section; R₀ represents a radius of a circle corresponding to the concave arc transition section; and Lₛ represents a length of the overflow pipe.

In an embodiment, points on the concave arc transition section satisfy formula (5):

$$x - \sqrt{{R}_{0}^{2} - {z}^{2} + 2 {zL}_{u} + 2 {zL}_{t} - {L}_{u}^{2} - 2 {L}_{u} {L}_{t} - {L}_{t}^{2}} = \frac{{D}_{s}}{2} , {L}_{u} + {L}_{1} + {L}_{2} \leq z \leq {L}_{u} + {L}_{t} ; \qquad ( 5 )$$

wherein Lₜ=L₁+L₂+L₃.

In an embodiment, a length L_{z} of the swirl chamber is 70˜75 mm; the length Lᵤ of the underflow pipe is 390˜420 mm; Lₜ is 410˜450 mm; and the inner diameter Dᵤ of the underflow pipe is 8-10 mm.

Compared to the prior art, this application has the following beneficial effects.

1. With respect to the demulsification and dehydration device provided herein, the swirl chamber and the underflow pipe are smoothly connected by a composite curved pipe section, which makes the distribution of tangential velocity, axial velocity and vorticity of the emulsion in the swirler more symmetrical, and makes the internal flow field more stable, promoting the outflow of the high-oil component from the overflow port, and improving the separation effect and efficiency.

2. The composite curved pipe section is composed of a concave arc transition section, a straight cone transition section and a convex elliptical arc transition section, which not only realizes the smooth transition connection, but also reduces the separation space between the swirl chamber and the underflow pipe, and increases the centrifugal force applied to the droplets, facilitating the movement of the droplets to the inner wall of the swirler and promoting the oil-water separation.

3. The separation space formed at the zone corresponding to the convex elliptical arc transition section is larger than that of the swirler with a traditional straight double-cone section and the swirler with a smooth dual-spherical surface transition section, which indicates a larger tangential cone angle and a larger contact area, such that the downward resistance of the fluid is increased, and a large amount of oil is forced to migrate to the overflow port, allowing for a better separation effect.

4. The inner diameter of the inlet pipe and the inner diameter of the swirl chamber are defined by a formula to match the inlet pipe and the swirl chamber better, thereby further improving the separation efficiency.

### BRIEF DESCRIPTION OF THE DRAWINGS

FIG. 1 is a schematic diagram of a swirler with a straight double-cone section in the prior art;

FIG. 2 schematically shows a swirler with a smooth dual-spherical surface transition section in the prior art;

FIG. 3 structurally illustrates a swirl-type demulsification and dehydration device for oil-water emulsions according to an embodiment of the present disclosure;

FIG. 4 schematically shows a swirl chamber according to an embodiment of the present disclosure;

FIG. 5 schematically shows a composite curved pipe section and an underflow pipe according to an embodiment of the present disclosure; and

FIG. 6 is a histogram showing comparison of different swirler structures in separation efficiency.

In the Figures: 1—underflow pipe; 2—convex elliptical arc transition section; 3—straight cone transition section; 4—concave arc transition section; 5—swirl chamber; 6—inlet pipe; 7—overflow pipe; 8—straight double—cone section; and 9—dual-spherical surface transition section.

### DETAILED DESCRIPTION OF EMBODIMENTS

The disclosure will be described in detail below with reference to the embodiments and accompanying drawings.

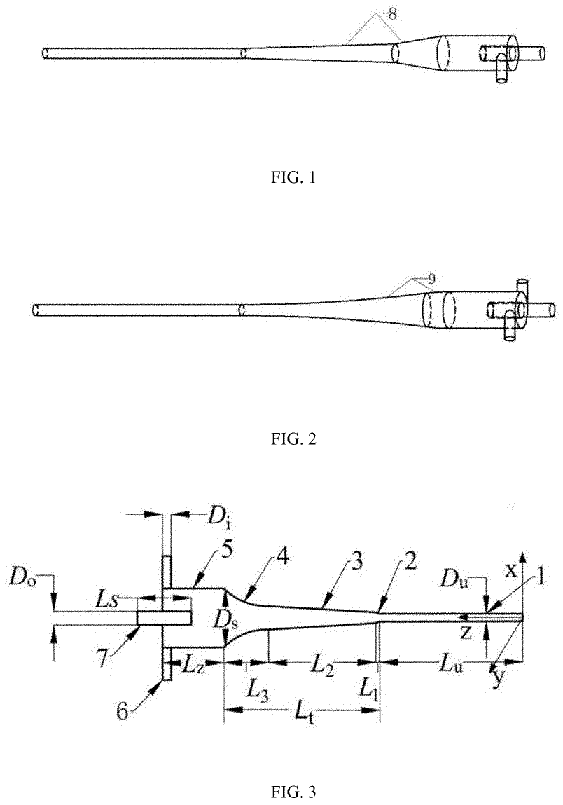

FIGS. 1-2 show two kinds of swirlers in the prior art respectively equipped with a straight double-cone section 8 and a dual-spherical surface transition section 9.

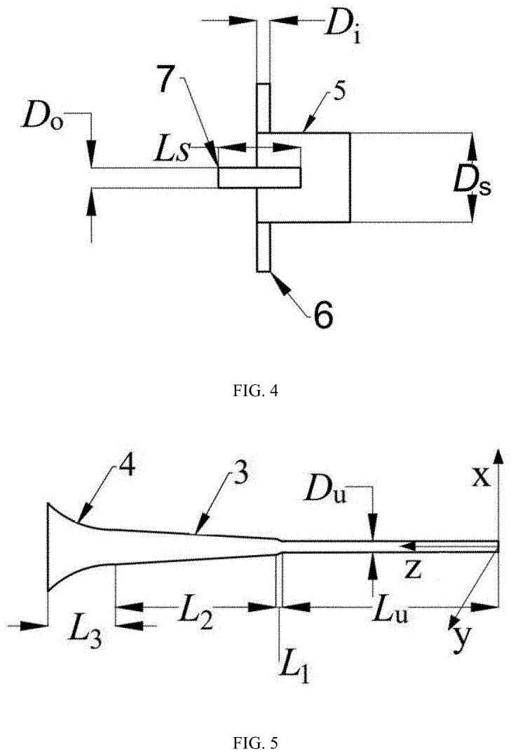

Referring to FIGS. 3-5, a swirl-type demulsification and dehydration device for oil-water emulsions is provided, which includes a swirler. The swirler includes a swirl chamber 5 and an underflow pipe 1. The swirl chamber 5 is cylindrical, and the underflow pipe 1 is coaxial with the swirl chamber 5. The swirl chamber 5 includes a closed end and an open end, and the closed end of the swirl chamber 5 is connected to an inlet pipe 6 and an overflow pipe 7. The overflow pipe 7 is coaxial with the swirl chamber 5. The inlet pipe 6 is tangent to a circumferential inner wall of the swirl chamber 5 and communicates with the swirl chamber 5. The overflow pipe 7 passes insulatively through the closed end of the swirl chamber 5 and communicates with the swirl chamber 5. A wall of the swirl chamber 5 and the overflow pipe 7 are made of conductive materials. The open end of the swirl chamber 5 faces towards the underflow pipe 1 and communicates with the underflow pipe 1 through a composite curved pipe section coaxial with the swirl chamber 5.

On an axial section of the swirler, an inner wall of the composite curved pipe section includes a concave arc transition section 4, a straight cone transition section 3 and a convex elliptical arc transition section 2 connected sequentially. A central angle corresponding to the concave arc transition section 4 and an eccentric corresponding to the convex elliptical arc transition section 2 are both less than 90°. A first end of the concave arc transition section 4 is connected to the open end of the swirl chamber 5. An inner diameter of the first end of the concave arc transition section 4 is equal to an inner diameter of the swirl chamber 5. A first end of the straight cone transition section 3 is tangent to a second end of the concave arc transition section 4. A second end of the straight cone transition section 3 is tangent to a first end of the convex elliptical arc transition section 2. A second end of the convex elliptical arc transition section 2 is connected to the underflow pipe 1. The first end of the concave arc transition section 4 is larger than the second end of the concave arc transition section 4 in diameter. The first end of the straight cone transition section 3 is larger than the second end of the straight cone transition section 3 in diameter. The first end of the convex elliptical arc transition section 2 is larger than the second end of the convex elliptical arc transition section 2 in diameter. The inner walls of the underflow pipe 1, the convex elliptical arc transition section 2, the straight cone transition section 3, the concave arc transition section 4 and the swirl chamber 5 are similar to rotary parts. Moreover, the swirler may be formed by a plurality of pipe segments connected one by one or may be formed in a cavity.

With respect to the demulsification and dehydration device, the swirl chamber 5 and the underflow pipe 1 are smoothly connected by the composite curved pipe section, which makes the distribution of tangential velocity, axial velocity and vorticity of the emulsion in the swirler more symmetrical, and makes the internal flow field more stable, promoting the outflow of the high-oil component from the overflow port, and improving the separation effect and efficiency. The composite curved pipe section includes the concave arc transition section 4, the straight cone transition section 3 and the convex elliptical arc transition section 2, which not only realizes the smooth transition connection, but also reduces the separation space between the swirl chamber 5 and the underflow pipe 1, and increases the centrifugal force applied to the droplets, facilitating the movement of the droplets to the inner wall of the swirler and promoting the oil-water separation. The separation space formed at the zone corresponding to the convex elliptical arc transition section 2 is larger than that of the swirler with the traditional straight double-cone section and the swirler with the smooth dual-spherical surface transition section, which indicates a larger tangential cone angle and a larger contact area, such that the downward resistance of the fluid is increased, and a large amount of oil is forced to migrate to the overflow port, allowing for a better separation effect.

In an embodiment, the number of the inlet pipe 6 is two. The two inlet pipes 6 are centrosymmetric with respect to an axis of the swirl chamber 5, thereby forming a high-speed vortex in the swirl chamber 5 and improving the separation effect and efficiency of the oil and water. In addition, in order to match the inlet pipe 6 with the swirl chamber 5 better and further improve the separation efficiency, a relationship between an inner diameter of each of the two inlet pipes 6 and the inner diameter of the swirl chamber 5 is expressed as follows:

Dᵢ=0.00312Dₛ²;

where Dᵢ represents the inner diameter of each of the two inlet pipes 6, and Dₛ represents the inner diameter of the swirl chamber 5.

In an embodiment, with respect to a spatial rectangular coordinate system established at a center of an end of the underflow pipe 1 with an extending direction of an axis of the underflow pipe 1 towards the overflow pipe 7 as a positive direction of z-axis.

In an embodiment, points on the underflow pipe 1 satisfy the following formula:

$$x = \frac{{D}_{u}}{2} , 0 \leq z \leq {L}_{u}$$

In an embodiment, points of the convex elliptical arc transition section 2 satisfy the following formula:

$$x - b \sqrt{1 - \frac{z - {L}_{u}}{a}} = \frac{{D}_{u}}{2} , {L}_{u} \leq z \leq {L}_{u} + {L}_{1}$$

In an embodiment, points on the straight cone transition section 3 satisfy the following formula:

$$x + K ( {L}_{u} + {L}_{1} ) - {K}_{z} = \sqrt{1 - \frac{{L}_{1}}{a}} + \frac{{D}_{u}}{2} , {L}_{u} + {L}_{1} \leq z \leq {L}_{u} + {L}_{1} + {L}_{2}$$

In an embodiment, points on the concave arc transition section 4 satisfy the following formula:

$$x - \sqrt{{R}_{0}^{2} - {z}^{2} + 2 {zL}_{u} + 2 {zL}_{t} - {L}_{u}^{2} - 2 {L}_{u} {L}_{t} - {L}_{t}^{2}} = \frac{{D}_{s}}{2} , {L}_{u} + {L}_{1} + {L}_{2} \leq z \leq {L}_{u} + {L}_{t}$$

In an embodiment, points on the swirl chamber 5 satisfy the following formula:

$$x = \frac{{D}_{s}}{2} , {L}_{u} + {L}_{t} \leq z \leq {L}_{u} + {L}_{t} + {L}_{z}$$

where x and z represent coordinates of a point on the x-axis and z-axis, respectively (x takes a positive value, which is the distance between the corresponding point and the axis of the swirler, respectively); a represents to a major axis of an ellipse corresponding to the convex elliptical arc transition section 2; b represents a minor axis of the ellipse corresponding to the convex elliptical arc transition section 2; Dᵤ represents the inner diameter of the underflow pipe 1; Lᵤ represents a length of the underflow pipe 1. Dₛ represents the inner diameter of the swirl chamber 5; R₀ represents a radius of a circle corresponding to the concave arc transition section 4; Lₛ represents a length of the overflow pipe 7; L_{z} represents a length of the swirl chamber 5, Lₜ=L₁+L₂+L₃, L₁ represents a length of the convex elliptical arc transition section 2; L₂ represents a length of the straight cone transition section 3; L₃ represents a length of the concave arc transition section 4.

In an embodiment, Kis a constant and satisfies the following formula:

$$K = \frac{\frac{{D}_{s} - {D}_{u}}{2} - \sqrt{{R}_{0}^{2} - {L}_{s}^{2}} + b \cdot \sqrt{1 - \frac{{L}_{3}}{a}}}{{L}_{2}}$$

In an embodiment, the length L_{z} of the swirl chamber 5 is 70˜75 mm, for example 70 mm, 73 mm or 75 mm. The length Lᵤ of the underflow pipe 1 is 390-420mm, for example 390 mm, 400 mm or 420 mm. Lₜ is 410˜450 mm, for example 410 mm, 430 mm or 450 mm. The inner diameter Dᵤ of the underflow pipe 1 is 8-10 mm, for example 8 mm, 9 mm or 10 mm. R₀ is 7-11 mm, for example 7 mm, 9 mm or 11 mm. a is 105˜115 mm, for example 105 mm, 110 mm or 115 mm; and b is 3-5 mm, for example 3 mm, 4 mm or 5 mm.

In an embodiment, how the device is operated is described as follows.

(1) The emulsion was pretreated. The water content of the pretreated emulsion was 5-25% by mass, and the kinematic viscosity of the pretreated emulsion at 40 ° C. was less than 46 mm²/s.

(2) The overflow pipe 7 was turned up, and the underflow pipe 1 was turned down. Then the overflow pipe 7 was electrically connected to a positive pole of the high-voltage pulse power supply, where the swirl chamber 5 was grounded.

(3) The pretreated emulsion was continuously input into the swirl chamber 5 from the inlet pipe 6. The two inlet pipes 6 were connected to two output ends of a t-branch pipe to ensure initial speeds of the two inlet pipes 6 consistent. The emulsion was continuously fed into the swirl chamber 5 at a specific speed through a helical rotor pump, where the speed of the emulsion in the inlet pipes was 6-14 m/s, and the pressure was 0.15˜0.3 MPa. (4) The oil discharged from the overflow pipe 7 and the water discharged from the underflow pipe 1 were respectively collected and transported.

In order to verify the swirl-type demulsification and dehydration device for an oil-water emulsion described in this application, the separation efficiency comparison is as follows.

The swirler with the traditional straight double-cone section, the swirler with the smooth dual-spherical surface transition section, the swirler with the composite curved pipe section were respectively used to perform demulsification and dehydration of the emulsions. All the three experimental conditions are consistent, including high-voltage pulse power supply, and flow rate, pressure, water content and kinematic viscosity of the emulsions, etc. According to the above steps, the length and diameter of each section of the swirler using the composite curve pipe section are as follows.

TABLE 1
Length and diameter of individual sections of the swirler

| Dₒ/ | Dᵢ/ | L_{z}/ | Lᵤ/ | Lₛ/ | Lₜ/ | Dₛ/ | Dᵤ/ | Rₒ/ | a, b/ |
|---|---|---|---|---|---|---|---|---|---|
| mm | mm | mm | mm | mm | mm | mm | mm | mm | mm |
| 18 | 12 | 75 | 400 | 75 | 430 | 70 | 10 | 9 | 109.4 |

Dₒ is the diameter of the overflow pipe 7, the length of each section of the swirler with the traditional straight double-cone section and the swirler with the smooth dual-spherical surface transition section was also set accordingly.

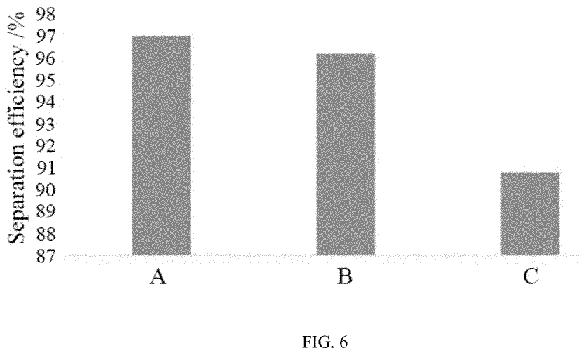

The test results are illustrated in FIG. 6, where A is the swirler with the composite curve pipe section, B is the swirler with the smooth dual-spherical surface transition section, and C is the swirler with the traditional straight double-cone section. It can be concluded that the separation efficiency of C can reach about 90%, the separation efficiency of B can reach about 96%, and the separation efficiency of A can reach about 97%. Compared with C, the separation efficiency of A is increased by about 7%, and compared with B, the separation efficiency of A is also increased by about 1%.

Firstly, in the swirler with the composite curve pipe section, the smooth connection between the swirl chamber and the underflow pipe makes the distribution of tangential velocity, axial velocity and vorticity of the emulsion in the swirler more symmetrical and makes the internal flow field more stable. Near the overflow port, the swirler with the composite curve pipe section can promote the liquid with high-oil component to flow out from the overflow port, thereby improving the separation effect and separation efficiency. In addition, the swirlers with the composite curve pipe section also have lower energy consumption and pressure drop.

In addition, in the swirler with the composite curve pipe section, the separation space between the swirl chamber and the underflow pipe is reduced, thereby increasing the centrifugal force applied on the droplets and facilitating movement of the droplets to the inner wall of the swirler to promote the oil-water separation. The separation space formed at the zone corresponding to the convex elliptical arc transition section is larger than that of the swirler with the traditional straight double-cone section and the swirler with the smooth dual-spherical surface transition section, which indicates a larger tangential cone angle and a larger contact area, such that the downward resistance of the fluid is increased, and a large amount of oil is forced to migrate to the overflow port, allowing for a better separation effect.

It can be obtained that the separation efficiency of the swirler with the composite curve pipe section is significantly higher than that of the swirler with the traditional straight double-cone section and the swirler with the smooth dual-spherical surface transition section.

It should be noted that the embodiments described above are only used to illustrate the technical solutions of the present disclosure, but not intended to limit the present disclosure. It should be understood that any modifications, changes and replacements made by those skilled in the art without departing from the spirit of the disclosure should fall within the scope of the disclosure defined by the appended claims.

What is claimed is:

1. A swirl-type demulsification and dehydration device for an oil-water emulsion, comprising:
a swirler;
wherein the swirler comprises a swirl chamber and an underflow pipe; the swirl chamber is cylindrical, and the underflow pipe is coaxial with the swirl chamber;
the swirl chamber comprises a closed end and an open end; the closed end of the swirl chamber is connected with an inlet pipe and an overflow pipe; the overflow pipe is coaxial with the swirl chamber; the inlet pipe is tangent to a circumferential inner wall of the swirl chamber, and communicates with the swirl chamber; the overflow pipe passes insulatively through the closed end of the swirl chamber, and communicates with the swirl chamber; a wall of the swirl chamber and the overflow pipe are made of a conductive material;
the open end of the swirl chamber faces towards the underflow pipe, and communicates with the underflow pipe through a composite curved pipe section; and the composite curved pipe section is coaxial with the swirl chamber;
on an axial section of the swirl, an inner wall of the composite curved pipe section comprises a concave arc transition section, a straight cone transition section and a convex elliptical arc transition section connected sequentially; and
a first end of the concave arc transition section is connected to the open end of the swirl chamber; an inner diameter of the first end of the concave arc transition section is equal to an inner diameter of the swirl chamber; a first end of the straight cone transition section is tangent to a second end of the concave arc transition section; a second end of the straight cone transition section is tangent to a first end of the convex elliptical arc transition section; a second end of the convex elliptical arc transition section is connected to the underflow pipe; the first end of the concave arc transition section is larger than the second end of the concave arc transition section in diameter; the first end of the straight cone transition section is larger than the second end of the straight cone transition section in diameter; the first end of the convex elliptical arc transition section is larger than the second end of the convex elliptical arc transition section in diameter; and an inner diameter of the second end of the convex elliptical arc transition section is equal to an inner diameter of the underflow pipe.

2. The swirl-type demulsification and dehydration device of claim 1, wherein the number of the inlet pipe is two; two inlet pipes are centrosymmetric with respect to an axis of the swirl chamber; and a relationship between an inner diameter of each of the two inlet pipes and the inner diameter of the swirl chamber is expressed as follows:
Dᵢ=0.00312Dₛ² (1);
wherein Dᵢ represents the inner diameter of each of the two inlet pipes, and Dₛ represents the inner diameter of the swirl chamber.

3. The swirl-type demulsification and dehydration device of claim 1, wherein a central angle corresponding to the concave arc transition section and an eccentric angle corresponding to the convex elliptical arc transition section are both less than 90°.

4. The swirl-type demulsification and dehydration device of claim 1, wherein with respect to a spatial rectangular coordinate system established at a center of an end of the underflow pipe with an extending direction of an axis of the underflow pipe towards the overflow pipe as a positive direction of z-axis, points on the convex elliptical arc transition section satisfy formula (2):
$$x - b \sqrt{1 - \frac{z - {L}_{u}}{a}} = \frac{{D}_{u}}{2} , {L}_{u} \leq z \leq {L}_{u} + {L}_{1} ; \qquad ( 2 )$$
wherein x and z represent coordinates of a point on an inner wall of the swirler on the x-axis and z-axis, respectively; a represents to a major axis of an ellipse corresponding to the convex elliptical arc transition section, and the major axis is in the same direction with an axis of the swirler; b represents a minor axis of the ellipse corresponding to the convex elliptical arc transition section; Lᵤ represents a length of the underflow pipe; Dᵤ represents the inner diameter of the underflow pipe; and L₁ represents a length of the convex elliptical arc transition section.

5. The swirl-type demulsification and dehydration device of claim 4, wherein points on the straight cone transition section satisfy formula (3):
$$x + K ( {L}_{u} + {L}_{1} ) - {K}_{z} = \sqrt{1 - \frac{{L}_{1}}{a}} + \frac{{D}_{u}}{2} , {L}_{u} + {L}_{1} \leq z \leq {L}_{u} + {L}_{1} + {L}_{2} ; \qquad ( 3 )$$
wherein K is a constant and satisfies formula (4):
$$K = \frac{\frac{{D}_{s} - {D}_{u}}{2} - \sqrt{{R}_{0}^{2} - {L}_{s}^{2}} + b \cdot \sqrt{1 - \frac{{L}_{3}}{a}}}{{L}_{2}} ; \qquad ( 4 )$$
wherein Ds represents the inner diameter of the swirl chamber; L₂ represents a length of the straight cone transition section; L₃ represents a length of the concave arc transition section; R₀ represents a radius of a circle corresponding to the concave arc transition section; and Lₛ represents a length of the overflow pipe.

6. The swirl-type demulsification and dehydration device of claim 5, wherein points on the concave arc transition section satisfy formula (5):
$$x - \sqrt{{R}_{0}^{2} - {z}^{2} + 2 {zL}_{u} + 2 {zL}_{t} - {L}_{u}^{2} - 2 {L}_{u} {L}_{t} - {L}_{t}^{2}} = \frac{{D}_{s}}{2} , {L}_{u} + {L}_{1} + {L}_{2} \leq z \leq {L}_{u} + {L}_{t} ; \qquad ( 5 )$$
wherein Lₜ=L₁+L₂+L₃.

7. The swirl-type demulsification and dehydration device of claim 6, wherein a length L_{z} of the swirl chamber is 70˜75 mm; the length Lᵤ of the underflow pipe is 390˜420 mm; Lₜ is 410˜450 mm; and the inner diameter Dᵤ of the underflow pipe is 8-10 mm.
